(19) United States
(12) Patent Application Publication
(10) Pub. No.: US 2010/0068017 A1
(43) Pub. Date: Mar. 18, 2010

(54) Cover, and Method for the Operation of a Cover

(76) Inventor: Andreas Geisenheiner, Schriesheim (DE)

Correspondence Address: Saul Ewing LLP (Philadelphia), Attn: Patent Docket Clerk, 2 North Second St., Harrisburg, PA, 17101, US

(21) Appl. No.: 12/516,943

(22) PCT Filed: Apr. 3, 2008
(86) PCT No.: PCT/EP08/53969

§ 371 Date: May 29, 2009

(30) Foreign Application Priority Data
Apr. 3, 2007 (DE) 10 2007 016 349.7
May 22, 2007 (DE) 10 2007 024 016.5

(51) Int. Cl. B65G 67/24; B65G 65/30; B65G 65/32; B65G 69/06

(52) U.S. Cl. 414/287

(57) ABSTRACT

The present invention relates to a covering, in particular pit covering. The covering according to the invention has moveable elements, at least one marginal region and a movement unit. The elements extend, at least in regions, over the space to be covered and are arranged essentially parallel to one another. The elements are in each case mounted rotatably and/or pivotably in relation to the marginal region and are moveable by the movement unit. The elements are dimensioned and arranged in relation to one another in such a way that the covering has a drive-on and/or walk-on capability. The present invention relates, further, to a method for operating a covering.

The present invention relates to a covering, in particular a pit covering. The present invention relates, further, to a method for operating a covering.

Coverings of the type initially mentioned are used, for example, in reception gutters in the wood-processing industry, for example in paper and cellulose works, where bulk material in the form of wood chips is delivered in large quantities.

In the unloading of bulk material from transporters, in particular from wood chip transporters (motor trucks and/or wagons), considerable quantities of bulk material are expelled per unit time. The bulk material has to be routed swiftly into a pit or into a low-lying reception gutter, without the unloading personnel undergoing any risk of falling or of injury or crushing. Thus, for example in the case of a motor truck with a sliding floor, 90 m³ of bulk material can be unloaded within the shortest possible time and therefore transferred onto the covering.

Since bulk material forms bridges, the bulk material may remain on a statically arranged grid-shaped covering and therefore does not pass through the grid. Such a heap of bulk material then has to be moved in relation to the statically arranged covering grid, for example by a wheeled loader or another aid, so that the bulk material passes through the grid. This is time-consuming and cost-intensive, and the grid may thereby be deformed or damaged.

If the grid has a coarse-mesh configuration, the grid has neither a drive-on nor a walk-on capability. To avoid the risk of an accident, such a grid is covered with a large-area cover plate. This, too, is costly and, furthermore, requires a very considerable amount of space for the cover plate which has to be moved in the horizontal direction over the grid or away from the grid.

There are solutions in which the pits have no grid-shaped covering, that is to say there is merely a pit or a hole. In this case, lateral barriers are provided, which have to be opened or removed before a motor truck or a railroad wagon can be unloaded. If, however, the motor truck is positioned at the pit for unloading and the barrier is removed or lowered, it is no longer possible for an operator to open the tailgate of the motor truck in order to initiate the unloading operation, since the operator can no longer walk behind the motor truck (that is to say, on a non-existent pit covering). It is possible, at most, to open the tailgate of the motor truck when the motor truck is still at a sufficient distance from the pit. In this case, however, bulk material may even fall off from the loading area of the motor truck, and this may make it impossible to carry out the furthermore required positioning or maneuvering of the motor truck at the pit for the effective unloading of the bulk material. In this solution, there is also the risk that the motor truck, a wheeled loader, a vehicle and/or an operator may fall into the pit, and this must be avoided under all circumstances for safety reasons.

Particularly in the paper and cellulose industry, acceptance stations for wood chips to be delivered are designed in such a way that the reception gutters are provided with gratings or oscillating bar grates or barriers. These only partially fulfill the requirements listed below. There is therefore a need for improvement. The requirements to be met by an improved covering are particularly:
different motor truck types, railroad wagons and/or containers are to be capable of being unloaded,
flexible and free docking with crossing by motor trucks and wheeled loader is to be possible,
there is to be no risk of falling for a vehicle, motor truck, motor truck driver, plant operator and/or quality controller,
footstep safety for opening the tailgate or a side door of motor trucks and for quality sampling is to be afforded,
the covering is to have no parts which entail critical injury risks,
the covering is to have no projecting edges,
a continuous and high bulk material throughput is to be possible,
the covering is to have a robust and repair-friendly design, and
a modular type of construction for the purpose of a parallel arrangement of a plurality of coverings is to be possible.

The object on which the present invention is based, therefore, is to specify and develop a covering and a method for operating a covering which can solve at least one problem listed above.

The covering according to the invention of the type initially mentioned achieves the above object by means of the features of patent claim 1. Accordingly, the covering according to the invention has moveable elements, at least one marginal region and a movement unit. The elements extend, at least in regions, over the space to be covered and are arranged essentially parallel to one another. The elements are in each case mounted rotatably and/or pivotably relation to the marginal region and can be moved by the movement unit. The elements are dimensioned and arranged in relation to one another such that the covering has a drive-on and/or walk-on capability. Such a covering serves particularly for covering a volume and/or a space. In concrete terms, the covering could be designed in the form of a pit covering. At least one of the elements could be designed in the form of a web.

It was therefore recognized, in the first place, that, with a grid floor having a grid pattern of approximately 250×250 mm, an open area of approximately 70% effective for the flow of bulk material is available. If the grid floor has a grid pattern of approximately 300×300 mm, an open area of even approximately 80% is available.

It nevertheless regularly happens that bulk material transferred onto such a grid floor cannot pass through this, the consequence being that the bulk material forms a heap. According to the invention, however, it was recognized that, for example in one embodiment of a covering according to the invention, an open area of only approximately 30% is sufficient. If the bulk material is transferred onto the elements in a position of rest, as a rule, heap formation is likewise observed. However, as soon as the elements are set in motion, a stable or continuous and mostly sufficient bulk material flow is thereby possible in spite of the relatively small open area. As a result of the pivoting or movement of the elements, a vertical movement of the corresponding parts of the elements which grows with the distance from the pivot axis or axis of movement occurs. This vertical movement is transmitted to the bulk material which is under the pressure of its deadweight and gives rise there to tectonic movements which disrupt or prevent any formations of bridges by the bulk material. The bulk material is positively mobilized. Not least, therefore, a predeterminable bulk material flow can be achieved advantageously by means of the covering according to the invention. Owing to the rotational, pivoting or pendulum movement of adjacent elements, the bulk material is also crushed or cut, thus likewise bringing about a conveyance of the bulk material. The bulk material conveyance caused thereby generally makes a smaller contribution than the bulk material conveyance caused by the vertical movements.

According to a preferred embodiment, the movement unit has at least one drive and at least one transmission element. The elements can be driven in a rotational, pivoting or pendulum movement by the at least one drive via the at least one transmission element. For example, an electric motor with a drive power of approximately 2 kW could serve as a drive. Elements with an overall length of 20 m can be driven thereby. This corresponds to a required drive power of 1 kW per 10 m of element length. The interaction between the elements and the transmission element could be configured such that the rotational, pivoting or pendulum movement of the elements has a deflection angle of up to +/−20 degrees.

Particularly preferably, the movement of the elements takes place by means of a repeated deflection or pivoting of the elements in one direction of rotation as far as a first reversal point. A deflection or pivoting of the elements in the opposite direction of rotation as far as the second reversal point then takes place. This operation is executed repeatedly.

In a particularly preferred embodiment, the elements are moved codirectionally. Accordingly, all the elements are deflected or rotated at the same time in the same direction. It is also conceivable in each case to move adjacent elements contradirectionally, in which case, for example, all even-numbered elements are deflected in one direction and all odd-numbered elements are deflected, virtually in phase opposition, in the direction opposite to this, if the elements are imagined with increasing numbering. It may also be advantageous to move all the elements codirectionally for a predeterminable time interval and in each case to move adjacent elements contradirectionally for a further predeterminable time interval. For this purpose, two transmission means could be provided which, for example, could be driven in each case by a drive. Even only one drive and two transmission means with a gear and with a coupling could be provided, by means of which the two transmission means can be driven in phase or in phase opposition, or only one transmission means can be driven.

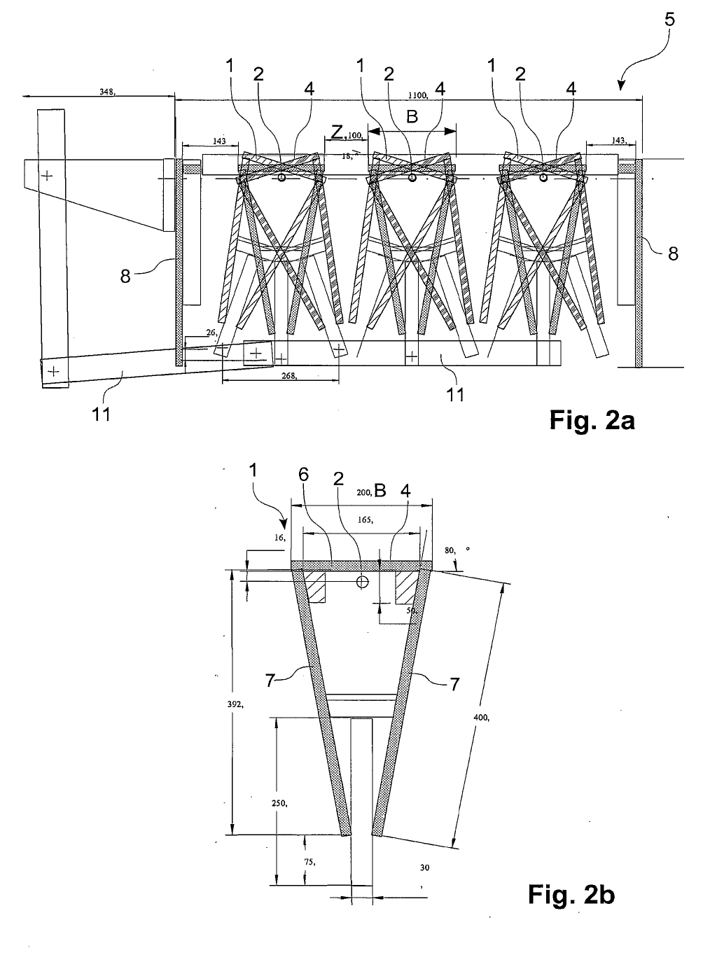

The elements could have a T-shaped, triangular, trapezoidal or polygonal cross section. A risk for persons of crushing could emanate from the side edge of a T-shaped element (pendulum bar). This embodiment is therefore less preferable, at least for some applications, because of safety requirements by the covering. A cladding of the critical edge (as shown, for example in FIG. 2b) advantageously does not impair the effectiveness of the pendulum principle. Accordingly, such elements may have a triangular or a trapezoidal cross section.

Preferably, the elements are designed in such a way that they withstand the introduction of high static and/or dynamic loads, so that vehicles, wheeled loaders or motor trucks can drive over them completely and/or partially. If the covering is to be designed, in terms of the introduction of loads, in such a way that motor trucks can drive over the covering partially or completely, such a covering should in any event be capable of absorbing an introduction of load of up to 15 t per element (for example, a motor truck axle with a load of 10 t).

According to an advantageous embodiment, an element has a longitudinal direction. The axis of rotation or pivot axis of an element is arranged parallel to the longitudinal direction. Preferably, the axis of rotation or pivot axis is arranged within the cross section of an element. According to this embodiment, therefore, an element is individually mounted rotatably or pivotably, for example by means of a shaft provided at one end region of the element and fastened to the element. This shaft could be mounted rotatably in a bearing of the marginal region.

Most particularly preferably, the elements are designed, arranged and moveable in such a way that at least one longitudinal edge of the surface part facing the bulk material executes at least partially a vertical movement if the elements are moved. To be precise, it was recognized that, by means of such vertical movements of the elements, tectonic movements in the accreted bulk material can be brought about, and the formation of bridges by the bulk material can thereby be disrupted or prevented. A vertical flow of the bulk material can thus be achieved.

According to one embodiment, an element has a surface which faces the bulk material. According to this embodiment, the elements are mounted at the marginal region in such a way that the surfaces of the elements are oriented essentially horizontally if the elements are in a state of rest. As a result, persons can walk on the covering and vehicles can drive on it.

At least one limitation means could be provided, by which the movement of the elements can be limited. For this purpose, a limitation or mechanical stops and/or a positive guide of the movement of the elements by mechanical means could be provided, which limits the movement, particularly a pendulum movement, of the elements to max. +/−25 degrees, preferably to +/−18 degrees. A retention of the elements in the position of rest could also be provided in order to prevent a deflection of individual elements, for example when a motor truck drives over the covering.

In the state of rest of the elements, between two adjacent elements, an interspace of predeterminable width which preferably has a value which lies in a range of between 80 and 150 mm could be provided. The gap width preferably amounts to a minimum of 100 mm, a maximum of 130 mm and, in particular, 110 mm, this being considered as an optimum between the risk of crushing and the risk of a false step. Even values deviating from this may be envisaged and depend, in particular, on the average size and nature of the bulk material which is used in each case and for which the covering is designed.

The surface of the elements which faces away from the space to be covered or faces the bulk material, or the upper region of the elements, could have a width, transversely to the longitudinal direction of the elements, which preferably has a value which lies in a range of between 150 and 250 mm. The width preferably has a value of 200 mm, thus ensuring footstep safety. In concrete terms, the elements could have a length which has a value which lies in a range of between 3000 and 7000 mm.

Preferably, the marginal region has a in particular vertically oriented side cladding which extends over a depth of at least 400 mm from the surface of the elements which faces the bulk material. Such an, if appropriate closed, side cladding of the elements or of the pendulum bars may be expedient particularly for shielding the dimensions of human limbs.

Preferably, the surface of the elements which faces the bulk material has a slip-inhibiting coating or at least one slip-inhibiting means, for example in the form of a stud plate provided on the surface or of a corresponding coating. Thus, for example, the material flow is not significantly reduced by profilings, elevations or obstructions on the top side of the elements. In concrete terms, the profilings could have a height of 10 mm and a width of 40 mm and be designed in the form of marginal strips.

A modular type of construction of a plurality of coverings is possible. To cover a space, at least two coverings are arranged next to one another so that a larger pit area can thereby be covered. As a result, advantageously, a plurality of motor trucks or railroad wagons can be unloaded next to one another and/or simultaneously. The coverings could be separately activated specifically for the situation. Thus, the elements of two coverings arranged next to one another could be moveable synchronously or independently of one another. A plurality of coverings could be arranged in one or more lines or rows arranged next to one another.

According to a preferred embodiments, a control device is provided for activating the moveable elements or the movement unit. The control device could activate the elements as a function of the bulk material applied to the covering, in such a way that the bulk material passes through the covering in a time-optimized or flow-optimized manner or in such a way that a predeterminable vertical volume flow of the bulk material passing through the covering can be achieved. Different program flows or activation flows could therefore be stored in the control device and could be retrievable as required.

Preferably, the area of the covering or the width of the interspaces between the elements is measured or dimensioned in such a way that a throughput with a vertical flow on average of 1 m/min is consequently possible or ensured. If, for example, the pivot angle of the elements amounts to only +/−14 degrees, the covering has a better or safer walk-on capability during a movement of the elements. Smoother running is obtained, and the bulk material throughput is not markedly lower than in the case of an angular movement of, for example, +/−18 degrees. In a concrete exemplary embodiment, the vertical flow achieved amounted to 0.8 m/min. The control device could therefore activate the movement of the elements in such a way that a predeterminable, preferably essentially constant volume flow of the bulk material passes through the covering.

The frequency of movement of the elements could have a predeterminable value. This value could amount, for example, to 1 Hz or could lie in a range of 0.1 Hz to 3 Hz. Fixing this value could depend on the type and nature of the bulk material to be processed. As a rule, the frequency of movement of the elements will have a constant value which remains unchanged while the covering is in operation. It could nevertheless be advantageous if the frequency of movement of the elements is variable.

Preferably an operating element is provided, by means of which the movement of the elements can be started, stopped and/or activated in at least two operating modes. The operating element could be designed in the form of a footswitch or in the form of a preferably mobile remote control.

A positive attainment of the planar position of the elements in the event of a stopping of the drive could be provided by means of control measures, if, for example, a plant operator actuates an emergency off device (for example, on the operating element). The elements are accordingly oriented with their upper face horizontally.

Bulk material coming under consideration is, in particular, all types of coarse and inhomogeneous bulk materials. In particular, the bulk material may be biomass or wood chips. The geometric and/or other properties of the covering could therefore be adapted to special features for the use of the covering for biomass or woodchips as bulk material.

According to a most particularly preferred embodiment, the elements are arranged level with the ground. Accordingly, the marginal region and a side cladding possibly provided must be arranged below or flush with the surface of the region around the covering. Arranging the elements level with the ground advantageously makes it possible for a motor truck or a wheeled loader to drive over the covering. The covering is accessible for persons in a simple way, and they can walk on it.

In terms of the method, the object initially mentioned is achieved by the measures of claim 26. Accordingly, a method for operating a covering, in particular for operating a pit covering, is defined. The covering comprises moveable elements, at least one marginal region and a movement unit. The elements extend, at least in regions, over the space to be covered and are arranged essentially parallel to one another. The elements are in each case mounted rotatably and/or pivotably in relation to the marginal region and can be moved by the movement unit. The elements are dimensioned and arranged in relation to one another in such a way that the covering has a drive-on and/or walk-on capability. Bulk material is transferred onto the covering, and, for the discharge or passage of the bulk material through the covering, the elements are set in motion.

The method according to the invention is suitable particularly for operating a covering according to one of claims 1 to 25, and therefore, to avoid repetition, reference is made to the preceding part of the description with regard to the relevant device features. In this case, the method steps required for operating the covering can be inferred by a person skilled in the present field from a knowledge of the disclosure content of the preceding part of the description.

A predeterminable or desired bulk material flow can be achieved particularly by means of a suitable setting of the pivot angle and/or of the frequency of movement of the elements. These could also be varied during operation.

Conventionally, an operation to unload a motor truck loaded with bulk material takes place as follows:
1. Surveying or estimation of the delivery volume
2. Assignment of an unloading gutter (for example, No. 3) covered by a covering according to the invention
3. Drive over covering No. 3 as far as 1 m, the elements being in the position of rest
4. Opening of the rear doors of the motor truck approximately 1 m into the covering
5. Start of motor truck sliding floor unloading at the motor truck
6. Start of the pendulum movement by footswitch
7. The duration of this operating phase amounts to approximately 10 min.
8. Stop of the pendulum movement by footswitch
9. Clearing and sweeping activity at the motor truck and covering
10. Departure of the motor truck.

In summary, some advantages of the covering according to the invention are listed below:
a floor-level arrangement of the covering is possible,
a drive over motor truck is possible in the planar position or position of rest of the elements,
persons can walk on the covering in the planar position or position of rest, and in this case, for example, vehicle doors can be opened or closed or the covering can be cleaned,
height equality of the bar top edge with the margin in the planar position is possible,
externally actuated activation of the movement of the elements, for example by foot-operated remote control, may be provided.

There are, then, various possibilities for advantageously implementing and developing the teaching of the present invention. In this respect, reference is to be made, on the one hand, to the patent claims coming after patent claim 1 and, on the other hand, to the following explanation of the preferred exemplary embodiments of the invention by means of the drawing. In conjunction with the explanation of the preferred exemplary embodiments of the invention by means of the drawing, generally preferred refinements and developments of the teaching are also explained. In the drawing:

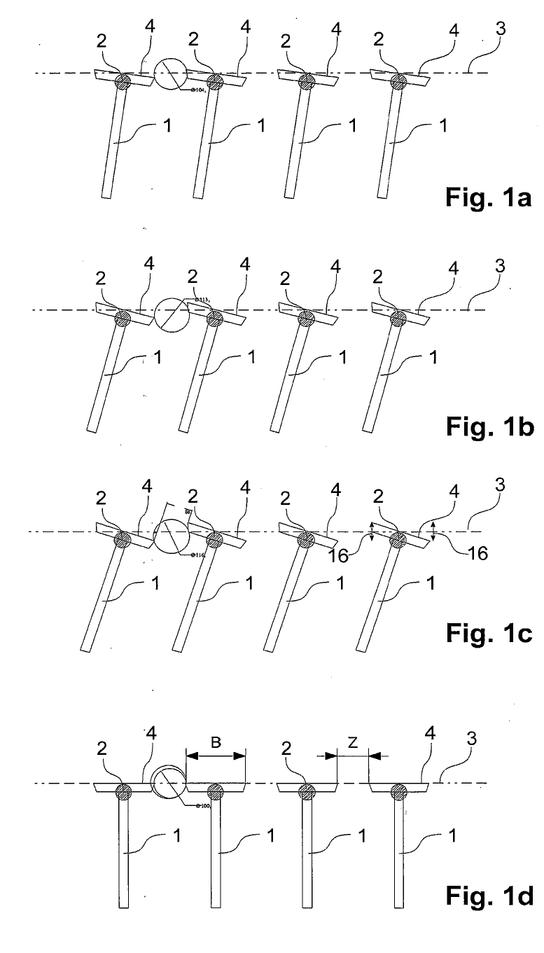

FIG. 1a shows a diagrammatic illustration of individual elements of a covering of a first exemplary embodiment according to the invention, the elements being in a first angular position,

FIG. 1b shows the elements from FIG. 1a in a second angular position,

FIG. 1c shows the elements from FIG. 1a in a third angular position,

FIG. 1d shows the elements from FIG. 1a in a position of rest,

FIG. 2a shows a diagrammatic illustration of a sectional view of a second exemplary embodiment of a covering according to the invention,

FIG. 2b shows a detailed sectional view of an element of the exemplary embodiment according to FIG. 2a,

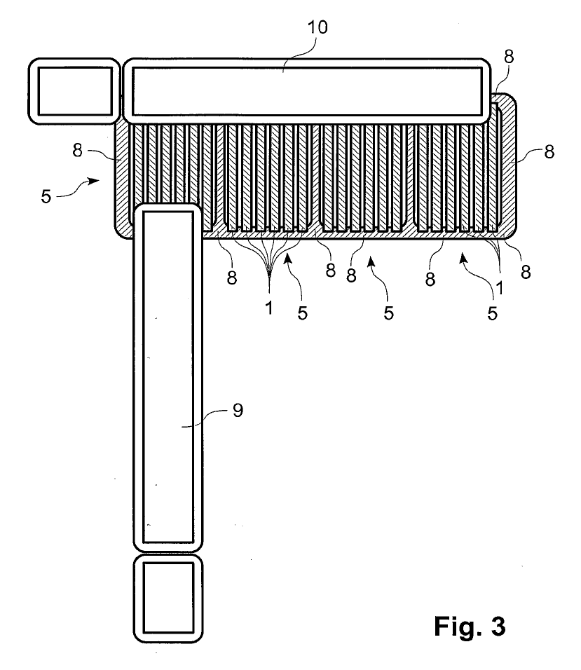

FIG. 3 shows a diagrammatic illustration of a plurality of coverings according to the invention arranged next to one another,

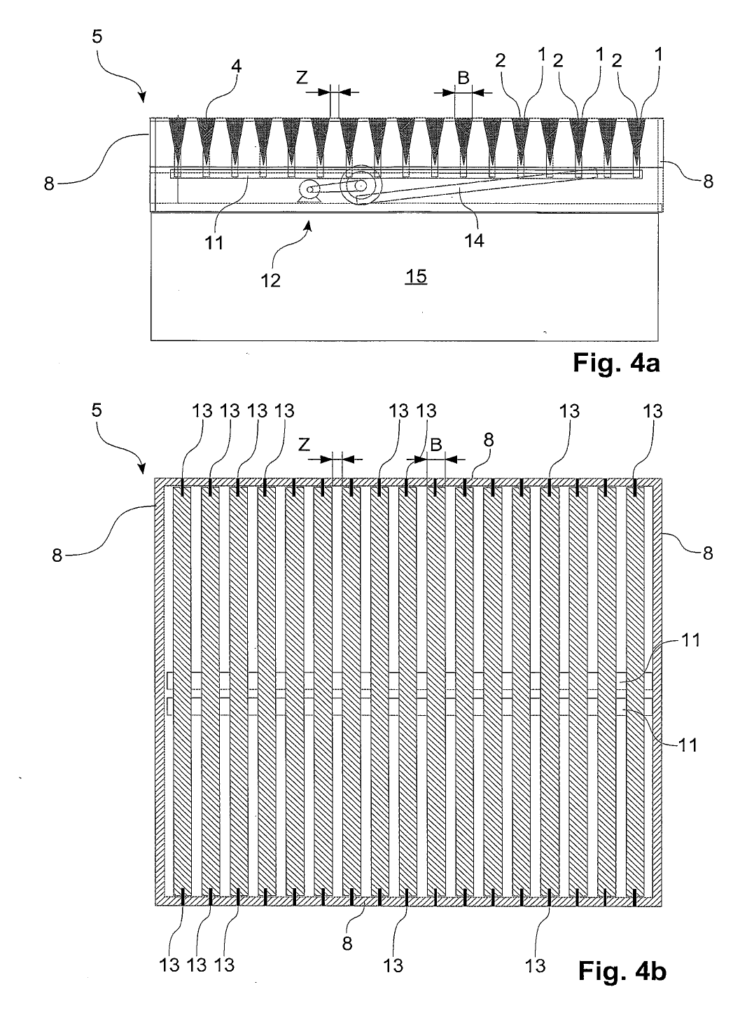

FIG. 4a shows a diagrammatic illustration of a sectional view of a third exemplary embodiment according to the invention of a covering, and

FIG. 4b shows a top view of the covering according to FIG. 4a.

Identical or similar components are identified in the Figures by the same reference symbols.

FIG. 1a shows individual elements 1 of a covering of a first exemplary embodiment according to the invention in a sectional view. The elements 1 are in a first angular position. The elements 1 have a T-shaped cross section. Reference symbol 2 shows the axis of rotation or pivot axis of the element 1 which runs perpendicularly with respect to the drawing plane. The elements 1 according to FIG. 1a are all deflected in the same direction, that is to say codirectionally or in phase, specifically at a first angle in relation to the horizontal, which is identified by reference symbol 3. The surface of the region around the covering extends at the same height as the horizontal 3 depicted in FIGS. 1a to 1d, thus resulting in an arrangement of the elements 1 which is level with the ground. In FIG. 1b, the elements 1 are deflected at a greater angle in relation to the horizontal 3, and, in FIG. 1c, they are finally deflected at a predeterminable maximum angle to the horizontal 3. Finally, in FIG. 1d, the elements 1 are shown in a position of rest in which the surface 4 of the elements is oriented parallel to the horizontal 3.

FIG. 2a shows a diagrammatic illustration of a sectional view of a second exemplary embodiment of a covering 5 according to the invention. In the covering 5, only three elements 1 are arranged next to one another. Two adjacent elements 1 have in this case a spacing Z of 100 mm. The elements 1 are shown in FIG. 2a in three different pivoting positions, to be precise at 0 degree and deflected at 18 degrees to the left and at 18 degrees to the right. The different pivoting positions of the elements 1 are indicated by different hatchings.

The element 1, shown, enlarged, in a sectional view in FIG. 2b, has an essentially plate-shaped design. Both the upper part 6 forming the surface 4 and the two side plates 7 may be formed from metal plates which, for production, may be welded to one another or correspondingly bent. The surface has a width B of 200 mm. The covering shown in FIG. 2a extends only over a region of 1100 mm. On the right of this, a further covering (not shown) is provided, which, together with the covering 5 shown in FIG. 2a, covers a space lying underneath. Reference symbol 8 identifies part of the marginal region or a side cladding of the covering 5, to be precise the part which is encompassed by the sectional view. The marginal region (not shown in FIG. 2a) provided on the end faces has corresponding bearing points, by means of which the elements 1 are in each case mounted rotatably about the axes of rotation 2. There too, a side cladding is provided.

FIG. 3 shows a diagrammatic top view of four coverings 5 arranged next to one another, the marginal region of each covering 5 likewise being identified by reference symbol 8. A motor truck 9 stands with its rear on the left covering 5, and the bulk material is unloaded at the rear onto the elements 1 of the left covering 5. These are in this case set in motion, so that a bulk material flow with as maximized a volume as possible can fall or be introduced into the reception gutter (not shown) provided below the covering 5. The motor truck 10, (this could also be a railroad wagon) stands with its left side transverse with respect to the four coverings 5. The motor truck 10 will unload the bulk material laterally. It may be gathered from FIG. 3 that the motor truck 10 has driven with the left wheels onto the coverings 5. Accordingly, the coverings 5 and, in particular, the elements 1 have a sufficient stability for this purpose. In other words, the elements 1 and their mountings at the marginal regional 8 are designed in such a way that they withstand such introductions of high static and dynamic loads.

FIG. 4a shows, in a sectional view, a diagrammatic illustration of a third exemplary embodiment of a covering 5 according to the invention. The seventeen elements 1 are of essentially triangular design in this exemplary embodiment. The elements 1 are driven or moved via a strut 14 with the aid of a transmission means 11 (to be precise, a strut to which the elements 1 are in each case fastened rotatably at their lower region) by the movement unit 12 which has an electric motor and a step-up gear. The covering 5 according to FIG. 4a extends over a length of approximately 5600 mm in this exemplary embodiment. Beneath the covering 5, a reception gutter or a pit 15 is provided, into which the bulk material (not shown) transferred onto the covering falls when the elements 1 of the covering 5 are moved. The bulk material located in the pit 15 is then transported to its intended location by means of a helical conveyor, not shown.

FIG. 4b shows the covering 5 from FIG. 4a in a top view. It can be seen that the marginal region 8 extends around the elements 1 in a rectangular or frame-shaped manner. It is indicated merely diagrammatically that the elements 1 are in each case mounted rotatably at opposite ends at the bearing points 13 in each case on the opposite marginal regions 8. The covering 5 according to FIG. 4a has a width of 5000 mm.

It is shown in FIG. 1c that the outer longitudinal edges of the elements 1 execute vertical movements during the pivoting movements. This vertical movement is indicated by the arrows 16. The larger the pivot angle of the elements 1 is, the greater the vertical movements are.

In conclusion, it may be pointed out most particularly that the exemplary embodiments dealt with above serve merely for describing the claimed teaching, but do not restrict this to the exemplary embodiments.

1. A covering for covering a volume or a space, in particular a pit covering, the covering having moveable elements, at least one marginal region and a movement unit, the elements extending, at least in regions, over the space to be covered and being arranged essentially parallel to one another, the elements being in each case mounted at least one of rotatably and/or pivotably in relation to the marginal region and being moveable by the movement unit, the elements being dimensioned and arranged in relation to one another such that the elements have a drive-on or walk-on capability.

2. The covering as claimed in claim 1, the movement unit having a drive and a transmission element, the elements being driveable by the drive via the transmission element in a rotational, pivoting or pendulum movement which preferably has a deflection angle of up to +/−20 degrees.

3. The covering as claimed in claim 1, the elements being moveable by the movement unit in such a way that the elements execute in each case a codirectional movement or in such a way that adjacent elements execute in each case a contradirectional movement.

4. The covering as claimed in claim 1, the elements having a T-shaped, triangular, trapezoidal or polygonal cross section or the elements being designed or mounted in such a way that they withstand the introduction of high static or dynamic loads and in such a way that, for example, an element can absorb an introduction of load of up to 15 t.

5. (canceled)

6. The covering as claimed in claim 1, an element having a longitudinal direction, the axis of rotation or pivot axis of an element being arranged parallel to the longitudinal direction, or an element having a longitudinal direction, the axis of rotation or pivot axis of an element being arranged parallel to the longitudinal direction and preferably the axis of rotation or pivot axis being arranged within the cross section of an element.

7. The covering as claimed in claim 1, the elements being designed, arranged and moveable in such a way that at least one longitudinal edge of the surface part facing the bulk material executes at least partially a vertical movement if the elements are moved.

8. The covering as claimed in claim 1, the elements having surfaces and a state of rest, and the surfaces of the elements being oriented essentially horizontally in the state of rest or at least one retention means being provided by which the elements can be retained in a position of rest or at least one limitation means being provided by which the movement of the elements can be limited.

9-10. (canceled)

11. The covering as claimed in claim 1, where in a state of rest of the elements, between two adjacent elements, an interspace of predeterminable width which preferably has a value which lies in a range of between 80 and 150 mm is provided.

12. The covering as claimed in claim 1, the surface of the elements which faces away from the space to be covered having a width which preferably has a value which lies in a range of between 150 and 250 mm or the elements having a length which has a value which lies in a range of between 3000 and 7000 mm.

13. (canceled)

14. The covering as claimed in claim 1, the marginal region having a preferably vertically oriented side cladding which extends over a depth of at least 400 mm from the surface of the elements which faces the bulk material.

15. The covering as claimed in claim 1, the surface of the elements which faces the bulk material having a slip-inhibiting coating or at least one slip-inhibiting means.

16. The covering as claimed in claim 1, at least two coverings being arranged next to one another in order to cover a space or at least two coverings being arranged next to one another in order to cover a space and the elements of two coverings arranged next to one another being moveable synchronously or independently of one another.

17. (canceled)

18. The covering as claimed in claim 1, a control device being provided which controls the movement of the elements or the control device activating the elements as a function of the bulk material applied to the covering, in such a way that the bulk material passes through the covering in a time-optimized or flow-optimized manner or in such a way that a predeterminable vertical volume flow of the bulk material passing through the covering is achieved.

19. (canceled)

20. The covering as claimed in claim 18, the control device controlling the movement of the elements in such a way that a predeterminable volume flow or an, essentially constant volume flow of the bulk material passes through the covering.

21. The covering as claimed in claim 1, the frequency of movement of the elements having a predeterminable value which lies in a range of between 0.1 Hz and 3 Hz and preferably amounts to 1 Hz or the frequency of movement of the elements being variable.

22. (canceled)

23. The covering as claimed in claim 1, an operating element being provided, by means of which the movement of the elements is started, stopped or activated in at least two operating modes.

24. The covering as claimed in claim 23, the operating element being designed in the form of a footswitch or in the form of a (mobile) remote control.

25. The covering as claimed in claim 1, the geometric or other properties of the covering being adapted to special features for the use of the covering for biomass or wood chips as bulk material.

26. The covering as claimed in claim 1, the elements being arranged level with the ground.

27. A method for operating a covering as claimed in claim 1, in particular for operating a pit covering, the covering having moveable elements, at least one marginal region and a movement unit, the elements extending, at least in regions, over the space to be covered and being arranged essentially parallel to one another, the elements being in each case mounted at least one of rotatably and/or pivotably in relation to the marginal region and being moveable by the movement unit, the elements being dimensioned and arranged in relation to one another in such a way that the elements have has a drive-on or walk-on capability, bulk material being transferred onto the covering, and, for the discharge or passage of the bulk material through the covering, the elements being set in motion.
